(19) United States
(12) Patent Application Publication
(10) Pub. No.: US 2026/0019691 A1
(43) Pub. Date: Jan. 15, 2026

(54) SENSOR UNIT FOR AN IMAGE CAPTURE DEVICE, IMAGE CAPTURE DEVICE AND METHOD FOR PRODUCING AN IMAGE CAPTURE DEVICE

(71) Applicant: Robert Bosch GmbH, Stuttgart (DE)

(72) Inventor: Johannes Eschler, Weil Der Stadt (DE)

(21) Appl. No.: 19/262,943

(22) Filed: Jul. 8, 2025

(30) Foreign Application Priority Data
Jul. 11, 2024 (DE) 10 2024 206 539.0

(51) Int. Cl. H04N 23/54; H04N 23/51; H04N 23/52

(52) U.S. Cl. CPC H04N 23/54; H04N 23/51; H04N 23/52

(57) ABSTRACT

A sensor unit for an image capture device for a vehicle. The sensor unit includes a sensor carrier having a receiving surface on which an image sensor is arranged, and having at least one connecting contour, and includes a housing element having at least one counter-connecting contour which is formed complementarily to the connecting contour, wherein the connecting contour and the counter-connecting contour are connected to one another in the mounted state of the sensor unit, and including a mounting portion for mounting an optical unit of the image capture device on the housing element.

### FIELD

The present invention is based on a sensor unit for an image capture device, an image capture device and a method for producing an image capture device. The present invention also relates to a computer program.

### BACKGROUND INFORMATION

Cameras are used in a wide range of fields, for example, in the automotive industry.

Germany Patent Application No. DE 10 2017 124 550 A1 describes a camera for a motor vehicle having at least two circuit boards and improved electromagnetic shielding, a camera system, a motor vehicle and a production method.

### SUMMARY

The approach of the present invention presented here provides an improved sensor unit for an image capture device, an improved image capture device and an improved method for producing an image capture device. Advantageous developments and improvements of the present invention are made possible by the measures set out in the disclosure herein.

The approach of the present invention presented can provide a possibility of producing an image capture device easily and cost-effectively. Advantageously, previously common components can be eliminated and thermal connection within the image capture device can be improved. Advantageously, the presented approach can realize a shape compatible with previous designs.

According to an example embodiment of the present invention, a sensor unit for an image capture device for a vehicle is presented, wherein the sensor unit comprises a sensor carrier having a receiving surface on which an image sensor is arranged, and having at least one connecting contour. The sensor unit also comprises a housing element having at least one counter-connecting contour that is formed complementarily to the connecting contour. The connecting contour and the counter-connecting contour are connected to one another in the mounted state of the sensor unit. Furthermore, the housing element comprises a mounting portion for mounting an optical unit of the image capture device on the housing element.

The sensor unit can therefore advantageously be designed as a component of an image capture device. The image capture device can preferably be designed as a camera that can be used for vehicles, for example with regard to driver assistance systems or for safety-relevant functions. A vehicle can be, for example, a passenger vehicle, a cargo vehicle or a commercial vehicle. The sensor carrier can, for example, be designed as a circuit that can be electrically and mechanically coupled to the image sensor. In the mounted state, the image sensor can be arranged facing an optical unit of the image capture device, wherein the receiving surface can also face the optical unit. Advantageously, the image sensor can be arranged centrally on the receiving surface. The connecting contour can advantageously be designed as an adhesive point at which the sensor carrier can be bonded to the housing element and thus an integral connection can be established. This can advantageously reduce production costs, since an adhesive bond can be inexpensive and easy to achieve. The housing element can advantageously be designed as a housing part of, for example, a plurality of housing parts or as a complete housing that at least partially surrounds the sensor carrier. For improved heat conductivity, the housing element can advantageously comprise a heat-conductive material, such as aluminum. The connecting contour and the counter-connecting contour and the integral connection thereof can advantageously promote heat dissipation from the sensor unit. Advantageously, the use of the connecting contour and the counter-connecting contour makes it possible to dispense with spacers. Advantageously, the counter-connecting contour can reduce creep of a heat-conducting medium.

According to one example embodiment of the present invention, the connecting contour and the counter-connecting contour can be connected to one another in an integral manner and additionally or alternatively in a form-fitting manner. Advantageously, the connecting contour and the counter-connecting contour can be or become bonded to one another. This can advantageously simplify the production of the sensor unit.

According to an example embodiment of the present invention, the sensor carrier can comprise a connecting web via which the receiving surface and the connecting contour can be connected to one another. Advantageously, the connecting web can reduce the load on the connecting contour and the counter-connecting contour which would act thereon due to thermal expansion, for example.

Furthermore, according to an example embodiment of the present invention, the receiving surface and the connecting contour can be elastically connected to one another via the connecting web. This can advantageously compensate for deflection, which can occur, for example, due to thermal load. Preferably, this can improve the sharpness of a captured image, since the thermally induced deflection can have no effect, or at least less effect, on the sensor carrier. As a result, a lower load can advantageously be exerted on the connecting contour.

According to one example embodiment of the present invention, a diameter of the connecting contour can be larger than a width of the connecting web. The connecting contour can have a rounded shape. This can advantageously have an advantageous effect on the elasticity of the connecting web and on the integral connection between the sensor carrier and the housing element.

In addition, according to an example embodiment of the present invention, the sensor carrier can comprise at least one copper layer that can extend towards the connecting contour. The copper layer can extend up to the connecting contour or up to just before the connecting contour, for example up to the connecting web. Since copper has the property of good heat conductivity, the use of the copper layer can advantageously improve the heat dissipation of the sensor carrier and thus also of the image sensor. This can advantageously reduce the susceptibility of the sensor unit to errors.

According to an example embodiment of the present invention, the connecting contour can have a rounded shape. The connecting contour can comprise an at least partially circular outline. Advantageously, the rounded shape can be formed by, for example, a punching process and can thus simplify production and reduce the costs of the sensor carrier.

According to an example embodiment of the present invention, the counter-connecting contour can be formed as a hollow cylinder which, in the mounted state, can surround the rounded shape over at least two-thirds of the circumference of the connecting contour. Advantageously, the counter-connecting contour can comprise a longitudinal opening as a hollow cylinder on a side facing the sensor carrier, which can advantageously be adapted to a width of a connecting web of the sensor carrier. As a result, a form fit can be achieved, so that the sensor carrier can be prevented from slipping out of the housing element.

According to one example embodiment of the present invention, the connecting contour can be designed as a contact nose. For forming the contact nose, a conventional method, such as a punching process, can advantageously be used so that production costs can be reduced. Advantageously, the contact nose can enable a form-fitting connection.

The counter-connecting contour can be formed as a contact projection that can engage with the contact nose. Advantageously, the sensor carrier and the housing element can be securely connected to one another in a form-fitting manner, as a result of which, for example, the load on the integral connection between the two parts can be relieved and thereby the stability of the sensor unit can be improved.

According to an example embodiment of the present invention, the sensor carrier can also comprise a plurality of connecting contours, wherein the connecting contours can be arranged at different corners of the sensor carrier. For example, the connecting contours can be arranged at adjacent corners and additionally or alternatively at opposite corners of the sensor carrier. Due to the positioning of the connecting contours, the stability of the sensor unit can advantageously be improved. Likewise, the housing element can comprise a plurality of counter-connecting contours, wherein the counter-connecting contours can be arranged at different corners of the housing element. For example, the counter-connecting contours can also be arranged at adjacent corners and additionally or alternatively at opposite corners of the sensor carrier. Due to the positioning of the counter-connecting contours, the stability of the sensor unit can advantageously be improved.

According to an example embodiment of the present invention, the sensor unit can comprise a heat-conducting means for dissipating heat, wherein the heat-conducting means can be arranged between the sensor carrier and the housing element. Additionally or alternatively, the heat-conducting means can be arranged between the connecting contour and the counter-connecting contour. The heat-conducting means can be, for example, heat-conducting paste, so that heat dissipation can be improved and thus the susceptibility to failure caused by overheating can be reduced. This means that process reliability can be increased. Advantageously, heat conduction can be scaled by an amount of the heat-conducting means.

Furthermore, the present invention provides an image capture device for a vehicle, wherein the image capture device comprises a sensor unit in an above-mentioned variant and an optical unit for directing light to the image sensor of the sensor unit, wherein the optical unit is mountable or mounted on the mounting portion of the housing element.

The image capture device can advantageously be designed as a vehicle camera, which can be used, for example, for safety-relevant functions and additionally or alternatively for assistance functions. The vehicle can be, for example, a passenger car, a truck or a commercial vehicle. The optical unit can advantageously also be referred to as an objective or objective unit and can therefore comprise a plurality of optical elements, such as lenses. Due to the optical elements, the light can be focused on a specific point, in this case the image sensor.

Furthermore, the present invention provides a method for producing an image capture device in an above-mentioned variant, wherein the method comprises a step of providing the sensor unit and the optical unit for directing light to the image sensor of the sensor unit, a step of mounting the optical unit on the mounting portion of the housing element, a step of positioning the sensor carrier in the housing element with a predefined alignment relative to the optical unit and a step of connecting the connecting contour of the sensor carrier to the counter-connecting contour of the housing element in order to connect the sensor carrier to the housing element.

For example, the method can be performed using at least one common production tool, which can reduce production costs because no special machine is required. In the step of positioning, the sensor carrier can be positioned in such a way that it and the optical unit lie on an optical axis. This means that the sensor carrier and the optical unit can be arranged one above the other. In the step of connecting, an integral and form-fitting connection of the connecting contour with the counter-connecting contour can advantageously be produced. In the step of positioning, a 5-axis or 6-axis alignment can advantageously be carried out.

This method of the present invention can be implemented, for example, in software or hardware or in a mixed form of software and hardware, for example in a control device.

Exemplary embodiments of the present invention are illustrated in the figures and explained in more detail in the following description.

### BRIEF DESCRIPTION OF THE DRAWINGS

FIG. 1 is a schematic representation of an exemplary embodiment of a image capture device, according to the present invention.

FIG. 2 is a schematic representation of an exemplary embodiment of a sensor unit, according to the present invention.

FIG. 3 is a schematic representation of an exemplary embodiment of a housing element, according to the present invention.

FIG. 4 is a schematic representation of an exemplary embodiment of a housing element, according to the present invention.

FIG. 5 is a schematic representation of an exemplary embodiment of a sensor carrier, according to the present invention.

FIG. 6 is a schematic representation of an exemplary embodiment of a sensor carrier, according to the present invention.

FIG. 7 is a flow chart of an exemplary embodiment of a method for producing an image capture device, according to the present invention.

### DETAILED DESCRIPTION OF EXAMPLE EMBODIMENTS

In the following description of advantageous exemplary embodiments of the present invention, the same or similar reference signs are used for the elements shown in the various figures and acting similarly, as a result of which a repeated description of these elements is omitted.

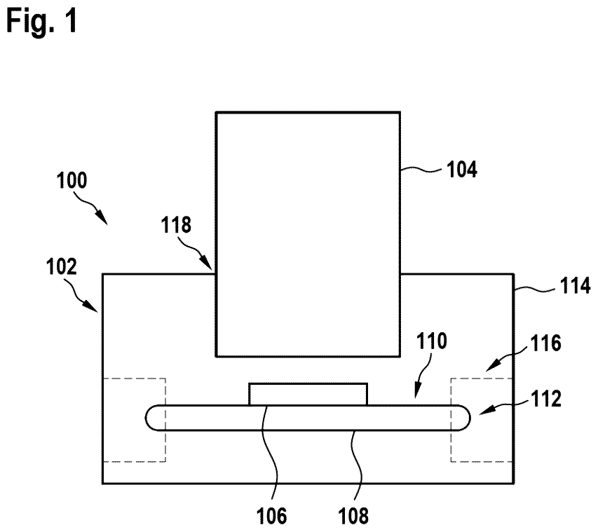

FIG. 1 is a schematic representation of an exemplary embodiment of an image capture device 100. The image capture device 100 can be used or is used in a vehicle, such as a passenger car. The image capture device 100 comprises a sensor unit 102 that is designed to capture an image, and an optical unit 104 for directing light to an image sensor 106 of the sensor unit 102. The optical unit 104 has, for example, a plurality of optical elements, such as lenses.

The sensor unit 102 comprises a sensor carrier 108, for example a circuit board, having a receiving surface 110 on which the image sensor 106 is arranged, and having at least one connecting contour 112. The connecting contour 112 is arranged, for example, on at least one corner of the sensor carrier 108 and is designed, for example, as an adhesive point in order to make an integral and/or form-fitting connection possible. The sensor unit 102 also comprises a housing element 114 having at least one counter-connecting contour 116, which is formed complementarily to the connecting contour 112. The connecting contour 112 and the counter-connecting contour 116 are connected to one another in the mounted state of the sensor unit 102. Furthermore, the housing element 114 comprises a mounting portion 118 for mounting the optical unit 104 of the image capture device 100 on the housing element 114. In other words, according to this exemplary embodiment, the optical unit 104 is mounted on or in the mounting portion 118.

Merely optionally, the image capture device 100 comprises a further housing element that surrounds at least one component of the image capture device 100. For example, the further housing element comprises a further counter-connecting contour for connecting to the connecting contour.

In other words, a so-called Satcam is described having a circuit board positioning and a heat-conducting means. The heat-conducting means is described in more detail below.

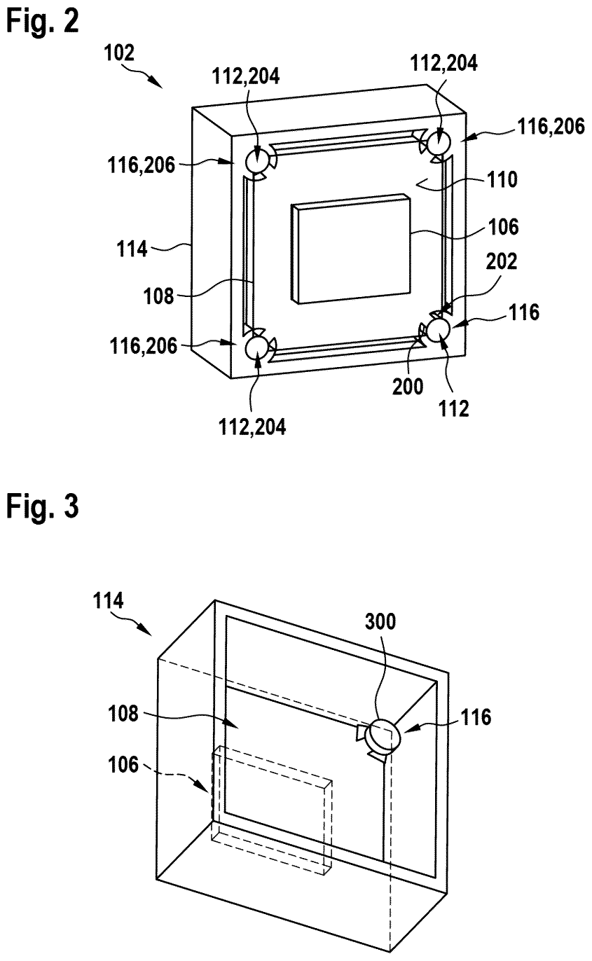

FIG. 2 is a schematic representation of an exemplary embodiment of a sensor unit 102, as described, for example, in FIG. 1. Here as well, the sensor unit 102 comprises the housing element 114 and the sensor carrier 108 with the image sensor 106, as described in FIG. 1. The image capture device is shown in FIG. 2 without the front housing part, so that only the sensor unit 102 is shown and the sensor carrier 108 and the image sensor 106 can be seen. According to this exemplary embodiment, the housing element 114 at least partially surrounds the sensor carrier 108 and comprises, for example, a heat-conducting material in order to dissipate heat from the housing interior. For example, the housing element 114 is formed from aluminum.

According to this exemplary embodiment, the connecting contour 112 and the counter-connecting contour 116 are connected to one another in an integral and form-fitting manner. The connecting contour 112 is also referred to, for example, as an adhesive point in order to connect the housing element 114 to the sensor carrier 108. The connecting contour 112 has a rounded shape. This means that the connecting contour 112 is designed to be round, but can also be designed to be oval, for example. According to this exemplary embodiment, the sensor carrier 108 further comprises a connecting web 200 via which the receiving surface 110 and the connecting contour 112 are connected to one another, in particular elastically. As a result, bends in the sensor carrier 108 caused, for example, by thermal expansion are compensated for. According to this exemplary embodiment, a diameter of the connecting contour 112 is greater than a width of the connecting web 200.

In order to connect the counter-connecting contour 116 and the connecting contour 112, the counter-connecting contour 116 is formed as a hollow cylinder which, in the mounted state, surrounds the rounded shape over at least two-thirds of a circumference of the connecting contour 112. This means that, according to this exemplary embodiment, an opening 202 of the hollow cylinder is arranged at the point at which the hollow cylinder does not surround the rounded shape. According to this exemplary embodiment, this opening 202 corresponds to the width of the connecting web 200. In addition, a length of the connecting web 200 corresponds, for example, to a width of the counter-connecting contour 116, so that a form-fitting connection is achieved. Optionally, the sensor carrier 108 additionally comprises at least one copper layer extending towards the connecting contour 112. This promotes heat dissipation, for example.

According to this exemplary embodiment, the sensor carrier 108 comprises a plurality 204 of connecting contours 112, wherein the connecting contours 112 are arranged at different corners of the sensor carrier 108. For example, the sensor carrier 108 according to this exemplary embodiment comprises four similarly realized connecting contours 112. Alternatively, the plurality 204 can also be arranged at diagonal corners and/or at an edge. Analogously, the housing element 114 comprises a plurality 206 of counter-connecting contours 116, wherein the counter-connecting contours 116 are arranged at different corners of the housing element 114. All counter-connecting contours 116 are designed identically according to this exemplary embodiment.

In other words, merely as an example, at least two connecting contours 112, which are also referred to as fixing points or adhesive points, are positioned in the corners or in two corners and on one or more longitudinal sides. At this point, the housing element 114 comprises the counter-connecting contours 116, also referred to as pockets, i.e., for example, ¾-circular cylinders, which enclose or encompass the connecting contours 112. The counter-connecting contours 116 are dimensioned so that the sensor carrier 108 can be positioned within the counter-connecting contours 116. This positioning is carried out, for example, as part of a 5-axis or 6-axis alignment. For example, the connecting contours 112 in the corners are circular for circuit board bonding. The connecting web 200 leads as a narrow web to the connecting contours 112, so that an elastic partial region is formed. The image sensor 106 is arranged near the center of the sensor carrier 108.

Under thermal load, a deflection of the sensor carrier 108 occurs due to an imbalance in the temperature expansion between the housing element 114 and the sensor carrier 108. Due to the elastic partial region, the load on the adhesive point, for example in the event of deflection or imbalance, is reduced.

FIG. 3 is a schematic representation of an exemplary embodiment of a housing element 114 as described, for example, in at least one of FIGS. 1 to 2. The sensor carrier 108 including the image sensor 106 is only sketched in FIG. 3 in order to indicate its position in the housing element 114. According to this exemplary embodiment, a heat-conducting means 300, such as heat-conducting paste, is arranged in a region of the counter-connecting contour 116 and is designed to dissipate heat. The heat-conducting means 300 is arranged or can be arranged between the sensor carrier 108 and the housing element 114. Additionally or alternatively, the heat-conducting means 300 is arranged between the connecting contour and the counter-connecting contour 116.

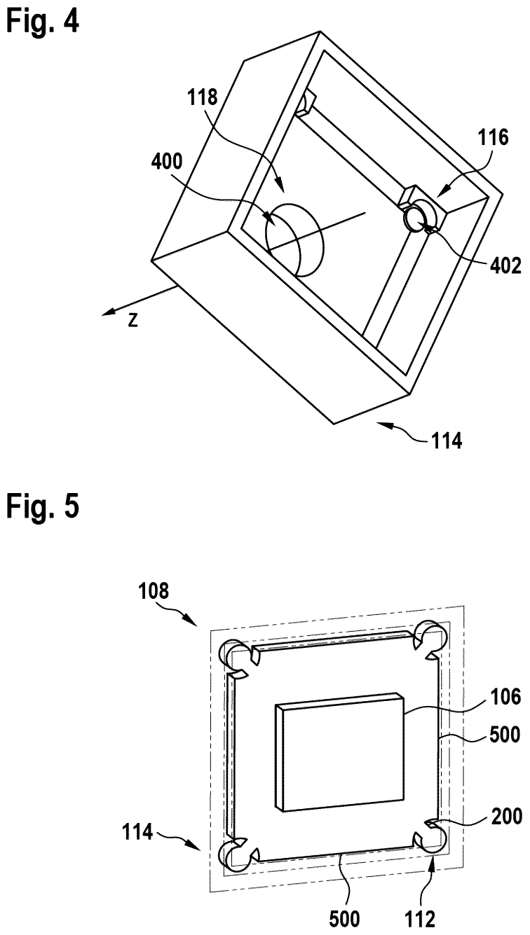

FIG. 4 is a schematic representation of an exemplary embodiment of a housing element 114 as described, for example, in at least one of FIGS. 1 to 3. FIG. 4 also shows the mounting portion 118 in or on which the optical unit can be attached. For this purpose, the mounting portion 118 comprises a through-opening 400. The sensor carrier, not shown in FIG. 4 for better clarity, is coupled to the counter-connecting contour 116, which comprises a stop 402 to which the connecting contour of the sensor carrier is bonded.

This means that, for example, a highly filled two-component epoxy adhesive is placed there. The adhesive can, for example, be dual-curing, wherein a pre-fixation with UV radiation takes place. For pre-fixation, for example, additional contours, if necessary, will be integrated into the adhesive point of the sensor carrier, also referred to as the circuit board. Typical layer thicknesses for the adhesive are, for example, between 100 μm and 800 μm.

FIG. 5 is a schematic representation of an exemplary embodiment of a sensor carrier 108, as described or at least mentioned, for example, in at least one of FIGS. 1 to 4. Here, the housing element 114 is only sketched. More precisely, a design of the sensor carrier 108 shown here corresponds to the sensor carrier 108 described in FIG. 2. As in FIG. 2, the connecting web 200 is arranged centrally on the connecting contour 112, so that the connecting web 200 has an equal distance to adjacent edges 500 of the sensor carrier.

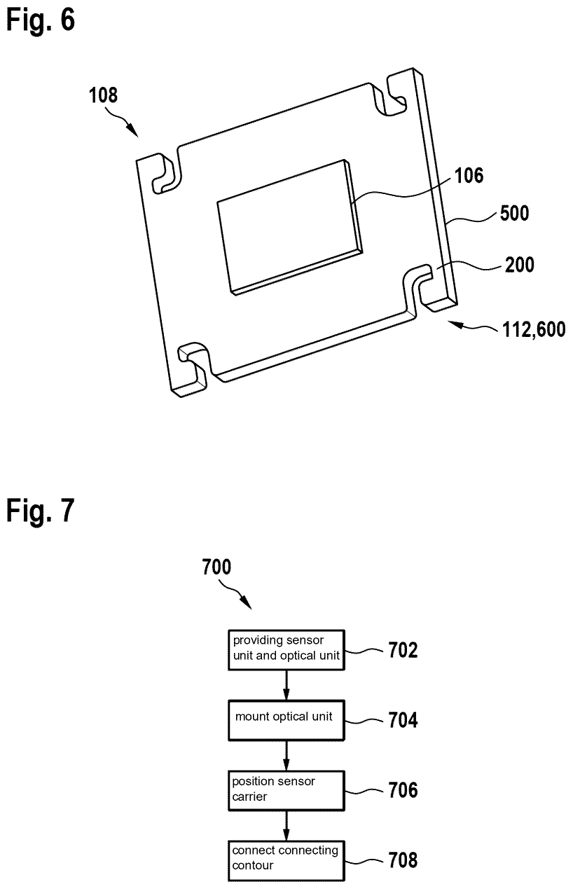

FIG. 6 is a schematic representation of an exemplary embodiment of a sensor carrier 108 which is similar, for example, to the sensor carrier described or mentioned in at least one of FIGS. 1 to 4. According to this exemplary embodiment, only a shape of the connecting contour 112 differs from the sensor carrier described in FIG. 5. This means that the connecting contour 112 according to this exemplary embodiment is designed as a contact nose 600. Likewise, the sensor carrier 108 according to this exemplary embodiment comprises the connecting web 200 via which the receiving surface 110 and the connecting contour 112 are connected to one another. However, according to this exemplary embodiment, the connecting web 200 is arranged on an edge 500 of the sensor carrier 108, in contrast to the sensor carrier described in FIG. 5. This means that the counter-connecting contour in this case is formed, for example, as a contact projection that engages the contact nose 600. Here, the connecting contour 112, and thus the contact nose 600, has for example a rounded shape at an end facing away from the connecting web 200.

FIG. 7 is a flow chart of an exemplary embodiment of a method 700 for producing an image capture device, as described, for example, in FIG. 1. For this purpose, the method 700 comprises a step 702 of providing, a step 704 of mounting, a step 706 of positioning and a step 708 of connecting. In step 702 of providing, the sensor unit and the optical unit for directing light to the image sensor of the sensor unit are provided. In step 704 of mounting, the optical unit is mounted on the mounting portion of the housing element. In step 706 of positioning, the sensor carrier is positioned in the housing element with a predefined alignment relative to the optical unit, for example in a common axis. In step 708 of connecting, the connecting contour of the sensor carrier is connected, for example in an integral and/or form-fitting manner, to the counter-connecting contour of the housing element in order to connect the sensor carrier to the housing element.

Solely by way of example, as part of the method 700, a highly filled two-component epoxy adhesive is arranged on the connecting contour. The adhesive can, for example, be dual-curing, so that a pre-fixation with UV radiation takes place. For pre-fixation, for example, additional contours, if necessary, are integrated into the adhesive point of the circuit board. Typical layer thicknesses for the adhesive are, for example, between 100 μm and 800 μm.

For example, once the circuit board has been fixed, a heat-conducting paste is optionally dispensed into the pockets in a dispensing process. Optionally, copper layers are positioned on the circuit board opposite the adhesive point, so that there is a transition between the circuit board and the housing with low temperature resistance.

Another advantage of the pocket structure is that the gap widths between the circuit board and the housing compensate one another during alignment, i.e. in the step 706 of positioning. The heat conduction changes only slightly during alignment and thus in the step 706 of positioning.

1-15. (canceled)

16. A sensor unit for an image capture device for a vehicle, the sensor unit comprising:
a sensor carrier having a receiving surface on which an image sensor is arranged, and having at least one connecting contour; and
a housing element having at least one counter-connecting contour that is formed complementarily to the connecting contour, wherein the connecting contour and the counter-connecting contour are connected to one another in a mounted state of the sensor unit, and having a mounting portion for mounting an optical unit of the image capture device on the housing element.

17. The sensor unit according to claim 16, wherein the connecting contour and the counter-connecting contour are connected to one another in an integral and/or form-fitting manner.

18. The sensor unit according to claim 16, wherein the sensor carrier includes a connecting web via which the receiving surface and the connecting contour are connected to one another.

19. The sensor unit according to claim 18, wherein the receiving surface and the connecting contour are elastically connected to one another via the connecting web.

20. The sensor unit according to claim 18, wherein a diameter of the connecting contour is greater than a width of the connecting web.

21. The sensor unit according to claim 16, wherein the sensor carrier includes at least one copper layer that extends towards the connecting contour.

22. The sensor unit according to claim 16, wherein the connecting contour has a rounded shape.

23. The sensor unit according to claim 22, wherein the counter-connecting contour is a hollow cylinder which, in the mounted state, surrounds the rounded shape over at least two-thirds of a circumference of the connecting contour.

24. The sensor unit according to claim 16, wherein the connecting contour is configured as a contact nose.

25. The sensor unit according to claim 24, wherein the counter-connecting contour is formed as a contact projection that engages in the contact nose.

26. The sensor unit according to claim 16, wherein the sensor carrier includes a plurality of connecting contours, wherein the connecting contours are arranged at different corners of the sensor carrier.

27. The sensor unit according to claim 26, wherein the housing element includes a plurality of counter-connecting contours, wherein the counter-connecting contours are arranged at different corners of the housing element.

28. The sensor unit according to claim 16, further comprising:
a heat-conducting arrangement for dissipating heat, wherein: (i) the heat-conducting arrangement is arranged between the sensor carrier and the housing element, and/or (ii) the heat-conducting arrangement is arranged between the connecting contour and the counter-connecting contour.

29. An image capture device for a vehicle, the image capture device comprising:
a sensor unit including:
a sensor carrier having a receiving surface on which an image sensor is arranged, and having at least one connecting contour, and
a housing element having at least one counter-connecting contour that is formed complementarily to the connecting contour, wherein the connecting contour and the counter-connecting contour are connected to one another in a mounted state of the sensor unit, and having a mounting portion for mounting
an optical unit of the image capture device on the housing element; and
an optical unit configured to direct light to the image sensor of the sensor unit, wherein the optical unit is mountable on the mounting portion of the housing element or mounted on the mounting portion of the housing element.

30. A method for producing an image capture device, the image capture device including:
a sensor unit including:
a sensor carrier having a receiving surface on which an image sensor is arranged, and having at least one connecting contour, and
a housing element having at least one counter-connecting contour that is formed complementarily to the connecting contour, wherein the connecting contour and the counter-connecting contour are connected to one another in a mounted state of the sensor unit, and having a mounting portion for mounting an optical unit of the image capture device on the housing element, and
an optical unit configured to direct light to the image sensor of the sensor unit, wherein the optical unit is mountable on the mounting portion of the housing element or mounted on the mounting portion of the housing element,
wherein the method comprises the following steps:
providing the sensor unit, and the optical unit for directing light to the image sensor of the sensor unit;
mounting the optical unit on the mounting portion of the housing element;
positioning the sensor carrier in the housing element with a predefined alignment relative to the optical unit; and
connecting the connecting contour of the sensor carrier to the counter-connecting contour of the housing element to connect the sensor carrier to the housing element.
